(19) United States
(12) Patent Application Publication
(10) Pub. No.: US 2006/0227098 A1
(43) Pub. Date: Oct. 12, 2006

(54) Gravity Control

(75) Inventor: Larry Donald Seldomridge, Rawlins, WY (US)

Correspondence Address: Mr.Larry Donald Seldomridge, 512 E. Murray St., Rawlins, WY, 82301, US

(73) Assignee: Larry Donald Seldomridge, Rawlins, WY (US)

(21) Appl. No.: 10/907,575

(22) Filed: Apr. 6, 2005

(51) Int. Cl. G09G 5/00

(52) U.S. Cl. 345/156

(57) ABSTRACT

My goal is to get the patent license and then sell, lease, or rent it to a gaming or manufacturing company for further development. I am just an individual not a company, I feel a larger company would have the means for a more precise manufacturing so the world can better utilize my idea. I thought of this idea about a year ago when playing on my Xbox. I believe once this is developed it could also have numerous applications in the modern electronic world. Thank You, very much for your time. I may also be interested in help marketing my patent. Respectfully yours, Larry Donald Seldomridge.

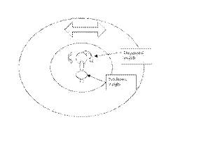

### SUMMARY OF THE INVENTION

The idea I have is for a video game controller device, here after to be known as “Gravity Control”. It may be used as a directional control as. Left to right, a steering wheel etc. It may also be used for the purpose as an automatic leveling control device.

Most steering wheels for video games must have a fixed axis for the switch in the steering wheel, or in other words it must be attached to something or have a 2 piece swivel. “Gravity Control” has a directional switch mounted inside the wheel with a pendulum hanging as the control lever. This can make your gaming object move left or right, also by putting another switch turned 90 degrees to the direction of this one it may also be used for up and down, or slower of faster, many possibilities. For example to control an airplane, car, or any avatar. As an option the switch may be sealed with the pendulum in a vicious fluid to dampen the movement and reaction.

What is claimed is:

1. The advantage of “Gravity Control” is to have a total game control with out it having to be attached to a fixed object.

2. For many games a steering wheel is a much easier and more precise way to control the object than a joy stick.

3. Also if the controller is made in a wireless version you have the ultimate controller.
